(19) United States
(12) Patent Application Publication
(10) Pub. No.: US 2013/0298003 A1
(43) Pub. Date: Nov. 7, 2013

(54) AUTOMATIC ANNOTATION OF CONTENT

(71) Applicant: Andrey N. Nikankin, Sankt-Petersburg (RU)

(72) Inventor: Andrey N. Nikankin, Sankt-Petersburg (RU)

(73) Assignee: RAWLLIN INTERNATIONAL INC.

(21) Appl. No.: 13/464,546

(22) Filed: May 4, 2012

(51) Int. Cl. G06F 17/21

(52) U.S. Cl. 715/230

(57) ABSTRACT

Generally described is auto annotation of content. A network service can receive at least partly textual content. The content can be automatically annotated to generate varying sets of the content. The varying sets of content can include varying levels of annotation to better meet user preferences or device capabilities. One or more of the varying sets of content can be output to a content browser, allowing a user of the content browser to see an annotated version of the content.

### TECHNICAL FIELD

This application relates to content management, and more particularly to automatic annotation of content at varying levels of detail.

### BACKGROUND

The proliferation of Internet hosted content has been a boon to academia, businesses, and consumers alike. Opinions, research articles, books, photographs, and video are just some of the content available to be viewed both privately and publicly through the Internet. Along with the growth in available content, there has been a similar growth in the types of devices that can be used to access that content. Computers, tablets, e-readers, and smart phones are just some of the categories of devices available to consumers and businesses to access content.

As the type of devices that can access content has grown, the capabilities of the devices have become segmented. For example, devices can have a color screen or a black and white screen, devices can have varying resolutions, devices can have varying screen sizes, devices can have varying processing power, etc. The varying capabilities of devices can present challenges in the consumption of content. For example, the user of a device, such as a desktop computer with a large monitor, may desire to view a long detailed research article in its entirety. To the contrary, a user of a smart phone with a three inch screen with limited screen resolution may instead only desire to see a brief abstract summarizing the article.

While the original author or creator of the content can create differing versions of the content, this relies on all authors to be good Samaritans to be useful on a grander scale. For the avoidance of doubt, the above-described contextual background shall not be considered limiting on any of the below-described embodiments, as described in more detail below.

### SUMMARY

The following presents a simplified summary of the specification in order to provide a basic understanding of some aspects of the specification. This summary is not an extensive overview of the specification. It is intended to neither identify key or critical elements of the specification nor delineate the scope of any particular embodiments of the specification, or any scope of the claims. Its sole purpose is to present some concepts of the specification in a simplified form as a prelude to the more detailed description that is presented in this disclosure.

Systems and methods disclosed herein relate to automatic annotation of content. An input component can receive content, wherein the content is at least partly textual content. An auto annotation component can generate differing sets of the content wherein a set among the sets of content is associated with a level of detail. An output component can send at least one set among the sets of the content to a content browser based on a specified level of detail.

In another embodiment, at least partly textual content can be received. Non-textual content associated with the at least partly textual content can be identified. Differing set of the content can be generated where the differing sets are associated with a textual level of detail and a non-textual level of detail. A subset of the differing set of content can be sent to a content browser based on a requested level of detail.

The following description and the drawings set forth certain illustrative aspects of the specification. These aspects are indicative, however, of but a few of the various ways in which the principles of the specification may be employed. Other advantages and novel features of the specification will become apparent from the following detailed description of the specification when considered in conjunction with the drawings.

### BRIEF DESCRIPTION OF THE DRAWINGS

FIG. 1 A illustrates example content;

FIG. 1B illustrates example content after a first stage of tokenization;

FIG. 2A illustrates example content after a second stage of tokenization;

FIG. 2B illustrates an example of parsing;

FIG. 2C illustrates an example of auto-annotated content;

FIG. 3 illustrates an example high level flow diagram for auto-annotation of content;

FIG. 4 illustrates an example network service;

FIG. 5 illustrates an example network service including a tokenization component;

FIG. 6 illustrates an example network service including a morphological component;

FIG. 7 illustrates an example network service including a parsing component;

FIG. 8 illustrates an example network service including a semantic component;

FIG. 9 illustrates an example network service including a context component;

FIG. 10 illustrates an example flow diagram method for auto annotation of content;

FIG. 11 illustrates an example flow diagram method for auto annotation of content further based on morphological features;

FIG. 12 illustrates an example flow diagram method for auto annotation of content further based on extracted meaning of the content;

FIG. 13 illustrates an example block diagram of a computer operable to execute the disclosed architecture; and

FIG. 14 illustrates an example schematic block diagram for a computing environment in accordance with the subject specification.

### DETAILED DESCRIPTION

The various embodiments are now described with reference to the drawings, wherein like reference numerals are used to refer to like elements throughout. In the following description, for purposes of explanation, numerous specific details are set forth in order to provide a thorough understanding of the various embodiments. It may be evident, however, that the various embodiments can be practiced without these specific details. In other instances, well-known structures and devices are shown in block diagram form in order to facilitate describing the various embodiments.

Systems and methods disclosed herein provide for auto annotation of content. The system provides for automatically creating different levels of abstraction of content where it was not previously available or explicitly provided. Content that is at least partly textual can be analyzed based on a combination of semantic features to determine key words, phrases, sentences, etc. that best represent a shorter version or versions of the textual content. It can be appreciated that through auto annotation, shorter versions of textual content like an article, a book, a description of associated non-textual content, etc. can relay key concepts or conclusions from the text in a smaller format that is more desirable for a user, or more easily consumed on a specific user device.

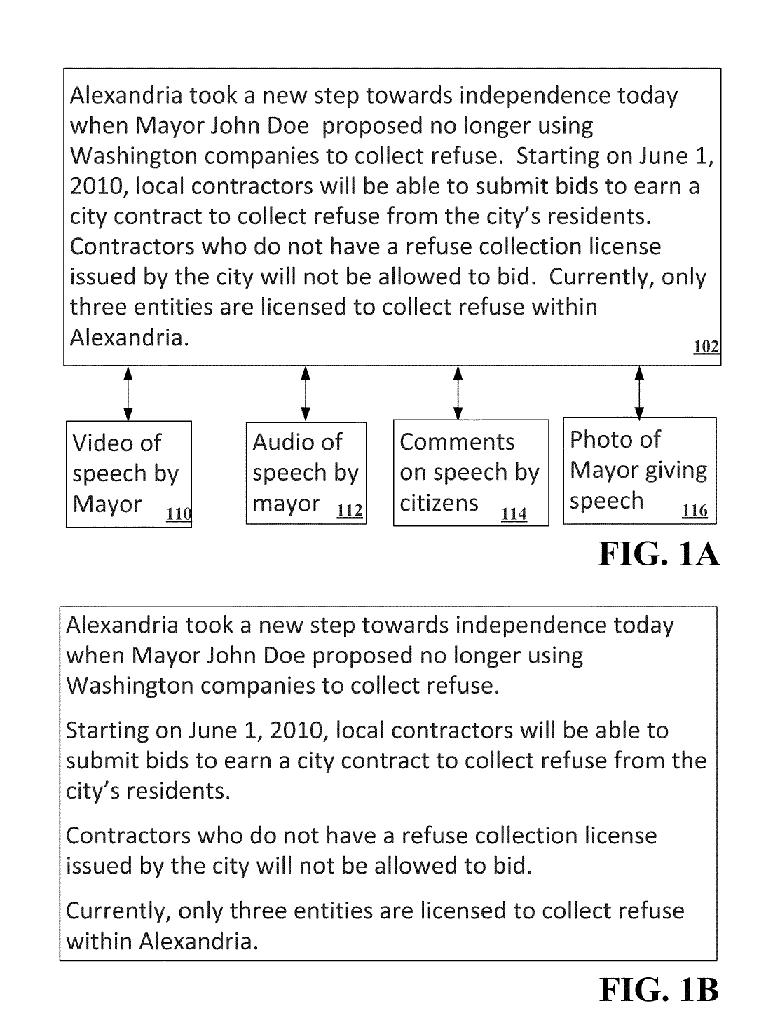

Referring now to FIG. 1A, there is illustrated example content. Block 102 denotes the at least partly textual content, in this example, a news article regarding a mayoral proposal. It can be appreciated that associated with the news article can be, for example, video of a speech by the mayor 110, audio of speech by the mayor 112, comments on speech by citizens 114, photos of the mayor giving the speech 116, etc. A news article is just one example of the type of at least partly textual content capable of being auto-annotated. For example, at least partly textual content could include: a research article with associated references, a description of associated video and audio content, aggregated product reviews, etc. Essentially, any content that is partly textual or includes a partly textual description is capable of being auto annotated. It can be appreciated that associated content such as video clips, audio clips, and photos are also capable of being auto annotated in accordance with various embodiments of the subject disclosure.

FIG. 1B illustrates example content after the first stage of tokenization. In the first stage of tokenization, original text can be divided into sentences. In this figure, the text in block 102 from FIG. 1A has been broken into sentences. In the example, four sentences have been separated into a set of sentences.

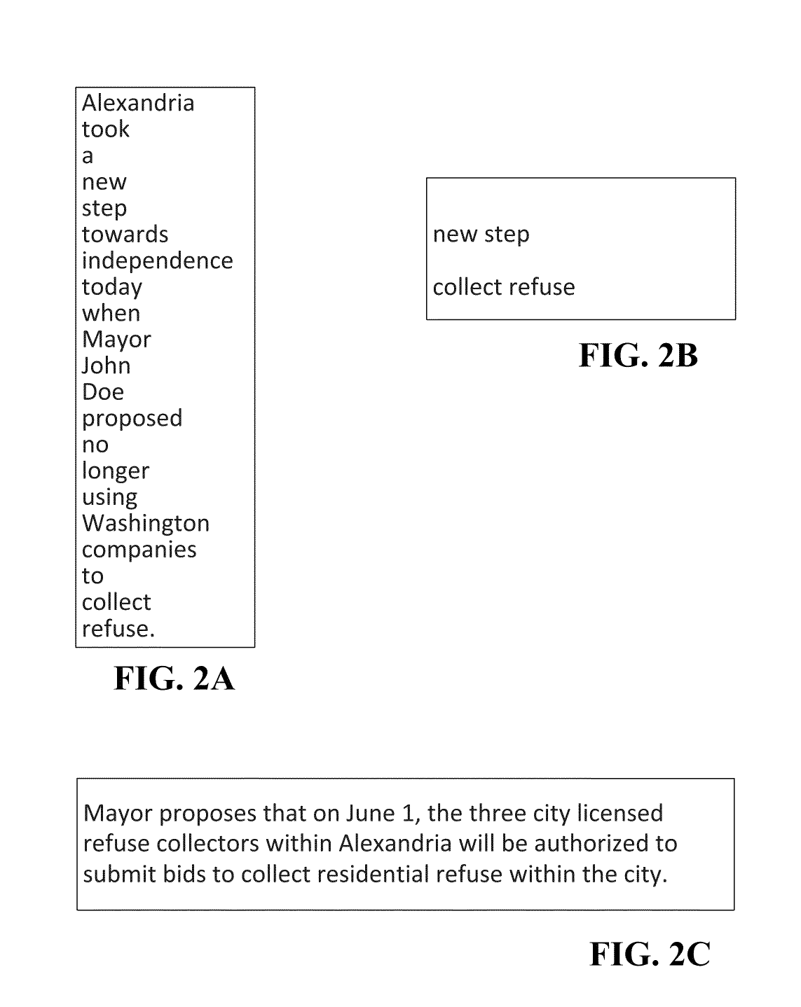

FIG. 2A illustrates example content after the second stage of tokenization. The second stage of tokenization divides the set of sentences into a set of words. For example, as depicted in FIG. 2A, the first sentence in the set of sentences from FIG. 1B has been separated into words. In this example, the sentence is comprised of twenty one words.

Morphological features can then be identified for each word in the set of words. Morphological features can include a part of speech, a gender, a case, a number, a date or a proper noun. For example, starting with the first word in the set of words, Alexandria can be identified as a noun that is capitalized. As “Alexandria” is the first word in the sentence, it is unclear during morphological analysis whether it is a proper noun or merely the first word in a sentence that is capitalized. Morphological analysis can proceed with every word in FIG. 2A. Some words can be multiple types of part of speech. For example, the word “new” can be either an adjective or a noun. Similarly, the word “refuse” can be either a verb or a noun. During morphological analysis, words with multiple possible “part of speech” delineations can be identified for further analysis during a parsing phase.

It can be appreciated that during a morphological analysis, a word dictionary, a phrase dictionary, a person data store, a company data store, or a location data store can be used in determining morphological features associated with a word. For example, the word “Alexandria” can be identified as both a name and a location, for example, Alexandria, Va. or Alexandria, Egypt.

FIG. 2B illustrates an example of parsing. Parsing can define subgroups of related words in a sentence. For example, adjective-verb or noun-verb combinations can be identified. The establishment of these subgroups can help determine ambiguities in morphological analysis. For example, the subgroup “new step” can assist in determining that “new” is used as an adjective, not a noun, as “step” would have an incorrect verb tense to modify “new” if “new” was a noun. In another example, the subgroup “collect refuse” can be identified. “Refuse” can be identified in morphological analysis as either a verb or a noun. Using parsing, the subgroup “collect refuse” can be identified as a verb-noun combination identifying that “refuse” as used in the sentence is a noun and not a verb. Parsing can provide additional insights that morphological feature analysis did not provide, allowing for morphological features to be updated after the parsing stage with the additional information learned.

Semantic analysis can follow parsing, and can be based off updated morphological features associated with the sets of words and sets of sentences. Semantic analysis provides for construction grade wood ties of words within a sentence, identifying the words and/or phrases necessary for “meaning ” In effect, semantic analysis is the extraction of meaning from the text. Using the set of words identified in FIG. 2A, key noun and verbs can be identified from the set of words that allow for meaning to be conveyed using a smaller set of words. For example, “Alexandria Mayor proposed new companies collect refuse” can convey similar meaning in six words as the original sentence did in twenty one words. In constructing meaning, the text can be searched for words, such as “Mayor”, on the basis of which a tree of relationships can be built from. Additionally, numbers signifying dates can be isolated, and predicate rules described in the OWL language can be used in conjunction with the morphological features.

Referring now to FIG. 2C, there is illustrated an example of auto-annotated content based on the block 102 from FIG. 1A. In the original text, seventy six words and four sentences were used to introduce the Mayor's proposal. The auto-annotated sentence of text as shown in FIG. 2C recites twenty seven words in one sentence in annotating the entirety of content. It can be appreciated that varying level of annotation can be generated, for example, a three sentence summary, a two sentence summary, etc. By producing differing versions of the same content, delivery of the content can made in a form that is most suitable for an individual user's desires or device capabilities.

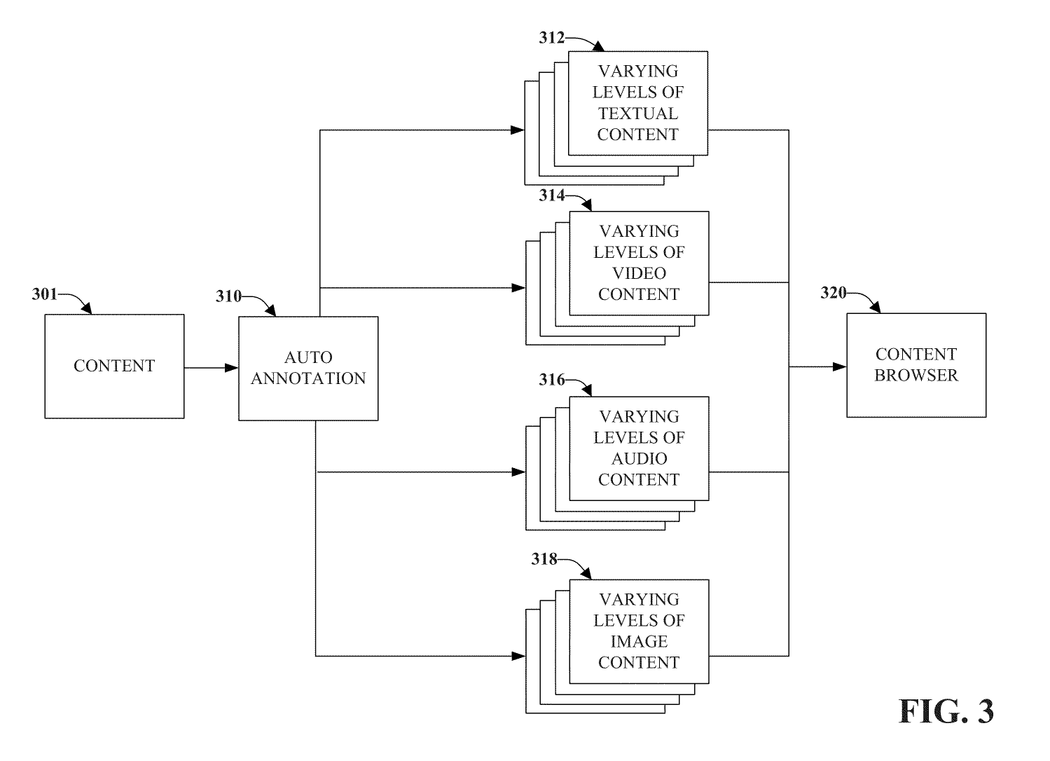

Referring now to FIG. 3, there is illustrated an example high level flow diagram for auto-annotation of content. Content 301 can include text, video, audio, images, etc. At 310, the content can be auto-annotated separating the various types of content in varying levels. For example, varying levels of textual content 312 can be generated during auto-annotation 310 to provide for full scale original content, or varying degrees of annotated content. The levels of textual content can be honed to fit the screen size and/or resolution of popular content browsing devices such as a smart phone, laptop computer, desktop computer, tablet computer, etc. Auto-annotation can also be tailored to the type of content. For example, a scientific paper on a research topic may retain more of the original content for better understanding than a movie summary, where every detail may not be important to understand the plot. In addition, user preferences can be established whereby users desire a level of annotation no matter what type of content is being displayed.

A content browser 320, such as an Internet browser or application can use the varying levels of content to select the most appropriate content based on user preferences or device capabilities. For example, screen size or resolution of a device can limit the types of non-textual content capable of being displayed. In addition, screen size and resolution can limit the amount of text comfortably being viewed on the screen. Certain users may also have content preferences unrelated to device capabilities. It can be appreciated that content browser 320 is capable of selecting multiple levels, a single level or no levels from the varying levels of content.

Similar to the varying levels of textual content 312, varying levels of video content 314 can also be auto-annotated at 310. For example, varying levels of video content 314 can include selecting and playing a smaller percentage of the total video, adjusting a video compression codec, adjusting a video size, etc. It can be appreciated that varying levels of video content can also include a level that completely eliminates video content from being viewed by content browser 320. For example, a user may not desire to have video content be displayed on their respective content browser, or alternatively, a device using content browser 320 may not be capable of displaying certain video content. It can also be appreciated that video compression and video size can be adjusted depending on a device that is seeking to access the content via content browser 320.

Varying levels of audio content 316 can also be auto annotated at 310. For example, audio compression, audio size, or audio length can all be adjusted to provide the varying levels of audio content 316. In one example, audio can focus on a specific speaker where other sections of the audio related to other speakers can be removed. For example, using audio of a speech from a mayor as shown in FIG. 1A, the audio clip can be analyzed and annotated to just select portions of the speech where the Mayor is actually talking removing dead time where no one is speaking, removing time when, for example, reporters are asking question, etc.

Varying levels of image content 318 can also be auto annotated at 310. Image compression, image size, or a number of images can all be annotated to provide varying levels of image content.

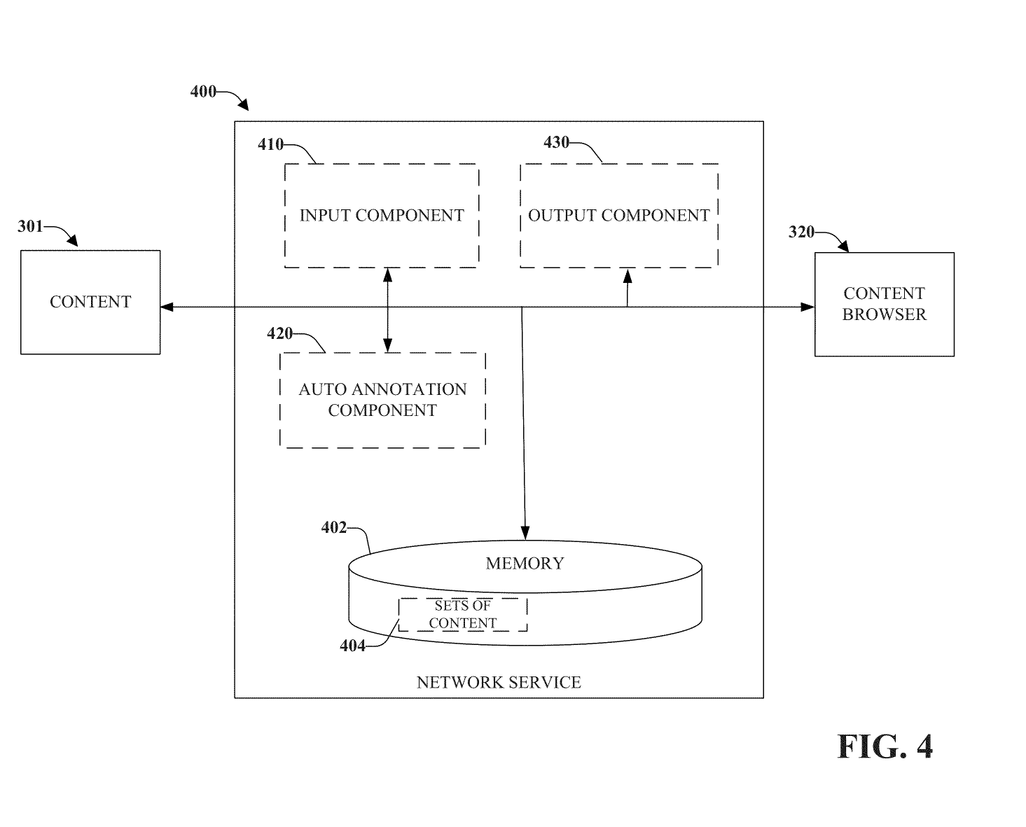

Referring now to FIG. 4, there is illustrated an example network service 400. Input component 410 can receive content 301, wherein the content 301 is at least partly textual. Content can include any information accessible in the network by network service 400 including Internet hosted information. Content can be associated with audio, video, or image content including being at least partly textual.

An auto annotation component 420 can automatically generate differing sets of the content in response to reception of the content wherein a set of the sets of the content is associated with a level of detail of a set of different levels of detail. It can be appreciated that the level of detail can include separate levels of detail associated with textual content, video content, audio content, image content, etc. Differing sets of content can include varying levels of annotation that retain varying amounts of the original content or supplements portions of the original content with new content that better summarizes the meaning of original content. Sets of content 404 can be stored within memory 402. It can be appreciated that memory 402 can be disparately located from network service 400.

Output component 430 can send at least one set among the sets of the content to a content browser 320 based on a specified level of detail. In one embodiment, output component 430 can send at least one set among the sets of the content to a content browser further based at least one of a user level of detail selection, a hardware profile, or a content browser setting

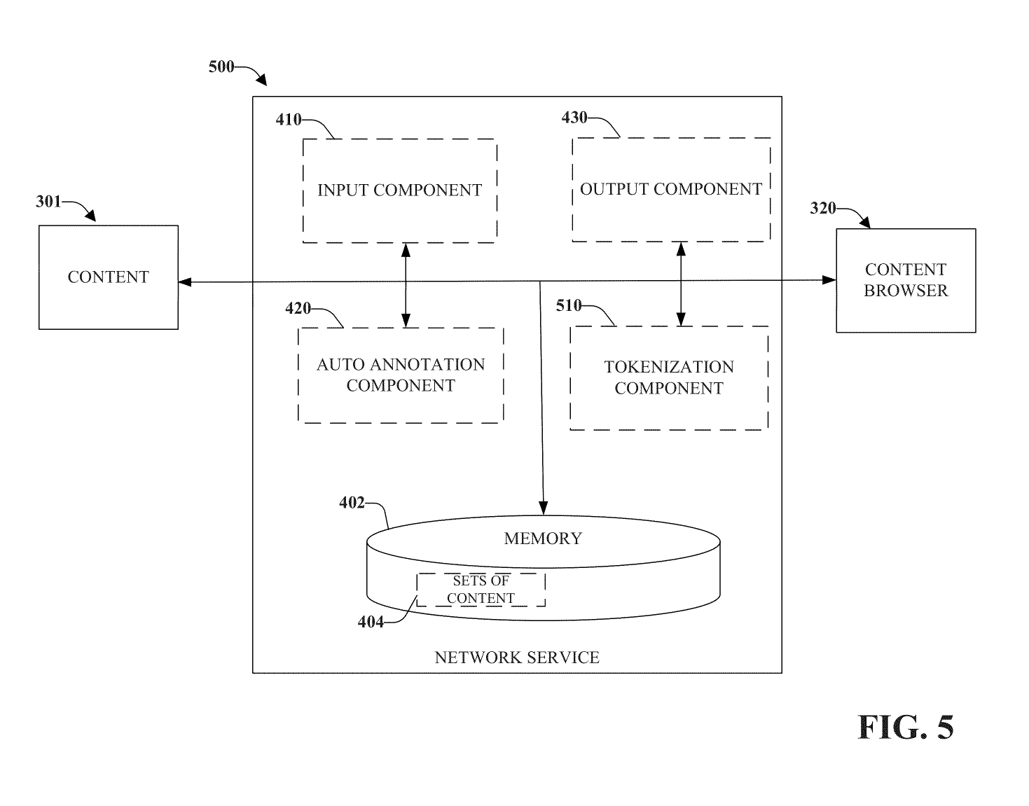

Referring now to FIG. 5, there is illustrated an example network service 500 including a tokenization component 510. Tokenization component 510 can divide textual content into a set of sentences. Tokenization component 510 can further divide sentences among the set of sentences into sets of words.

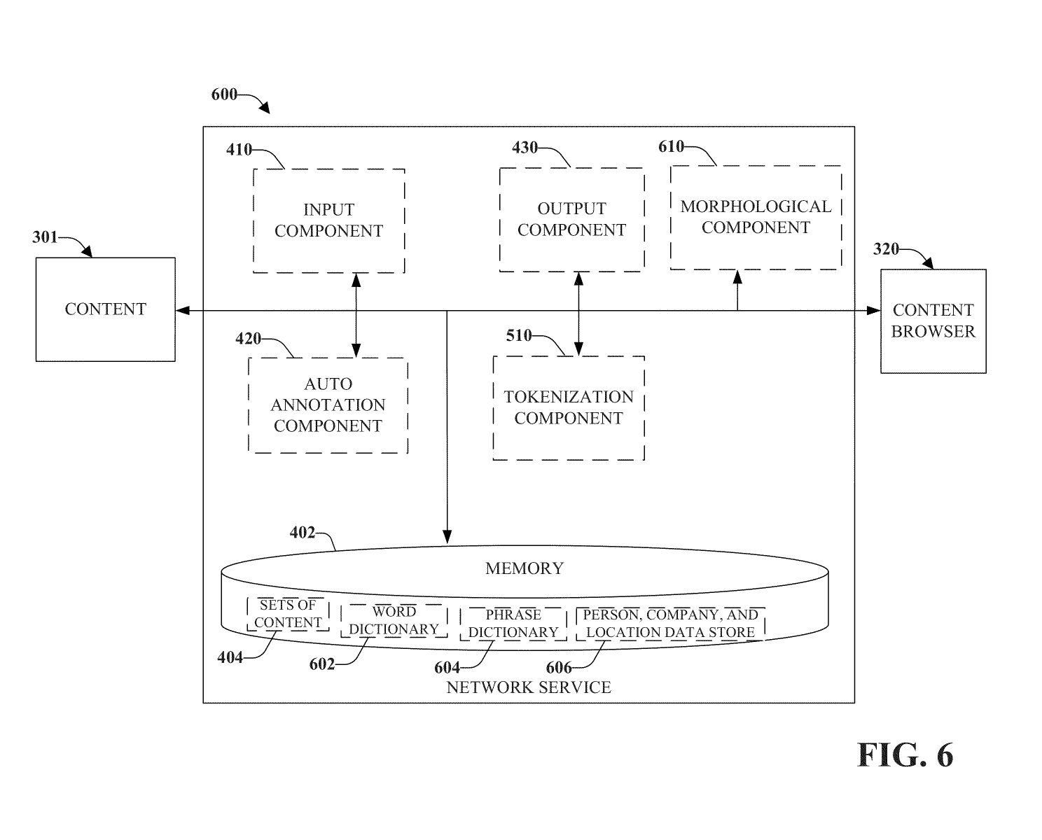

Referring now to FIG. 6, there is illustrated an example network service 600 including a morphological component 610. Morphological component 610 can identify morphological features for each word in the set of words. Auto annotation component 420 can generate differing set of content further based on the identified morphological features. Morphological features can include a part of speech, a gender, a case, a number, a date, a proper noun, etc. Morphological component 610 can use word dictionary 602, phrase dictionary 604 and person, company and location data store 606 stored within memory 402 in identifying morphological features. It can be appreciated that separate word dictionaries, phrase dictionaries, and person, company, and location data stores can exist for different languages.

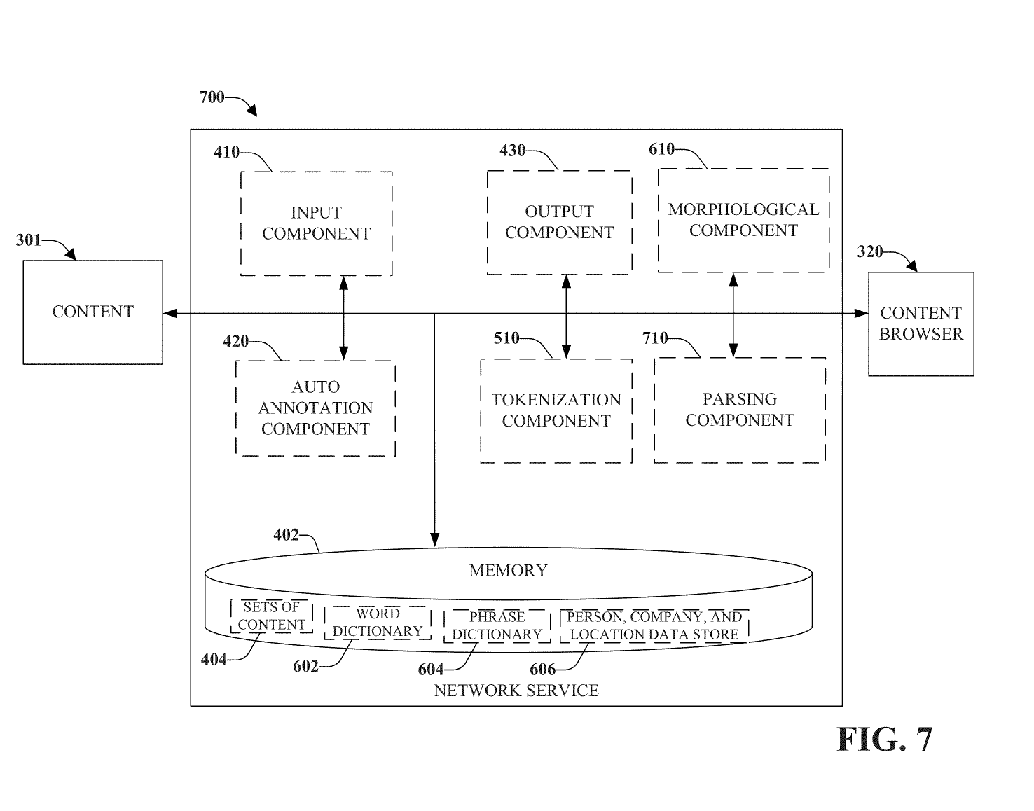

Referring now to FIG. 7, there is illustrated an example network service 700 including a parsing component 710. Parsing component 710 can determine, for the words in the set of words, a set of related words based on the morphological features. For example, if the morphological features associated with a word note more than one possibility for a part of speech the word could be belong to; parsing component can link the ambiguous word with neighboring words to form a set of related words. In one embodiment, morphological component 610 can further update morphological features associated with words among a set of words based on the set of related words among the set of words. For example, noting a noun-verb combination can help identify whether a word with ambiguous morphological features is actual a noun or an adjective.

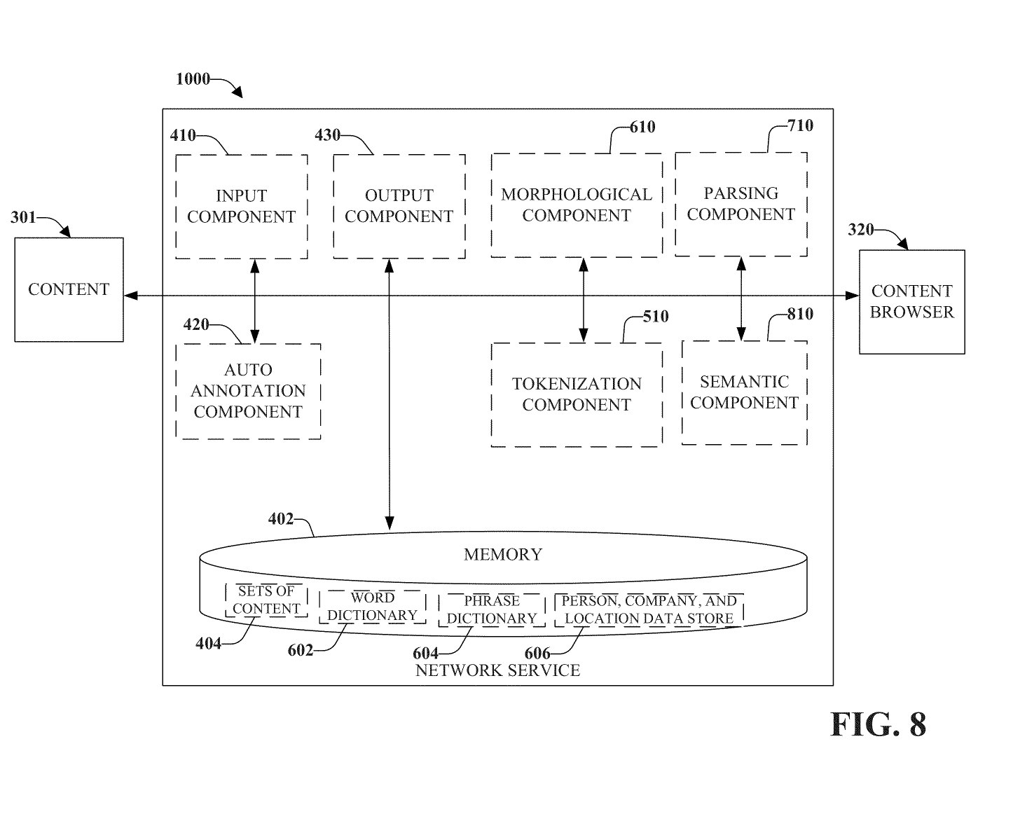

Referring now to FIG. 8, there is illustrated an example network service 800 including a semantic component 810. Semantic component 810 can extract meaning from the set of sentences based on the morphological features. For example, a tree can formed based on word relationship to better understand the meaning of all words within the tree. Words near the top of the tree can be given more importance and hence inclusion within annotated text.

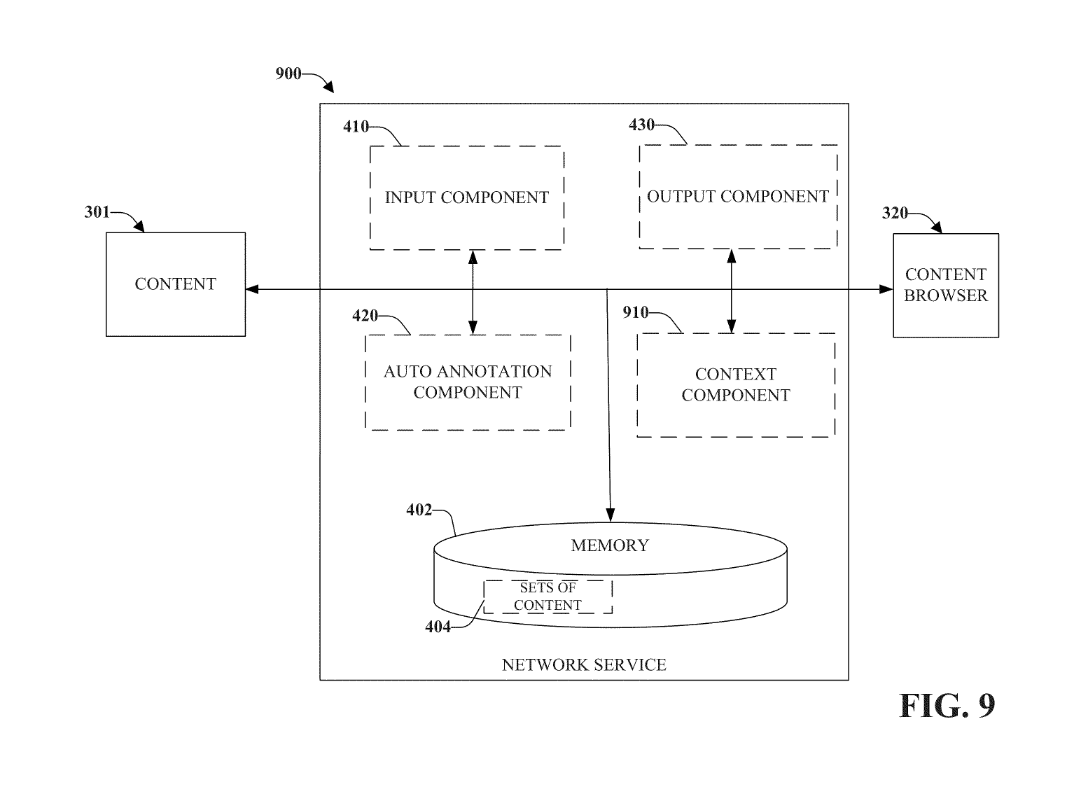

Referring now to FIG. 9, there is illustrated an example network service 900 including a context component 910. Context component 910 can determine at least one associated content wherein the associated content is at least one of an image, a sound or a video. Associated content can be annotated as well. For example, associated content can be repackaged with varying resolutions, compression algorithms, lengths, sizes, etc. In one embodiment, auto annotation component 420 can include associated content within the sets of content based on a level of detail associated with the set of content.

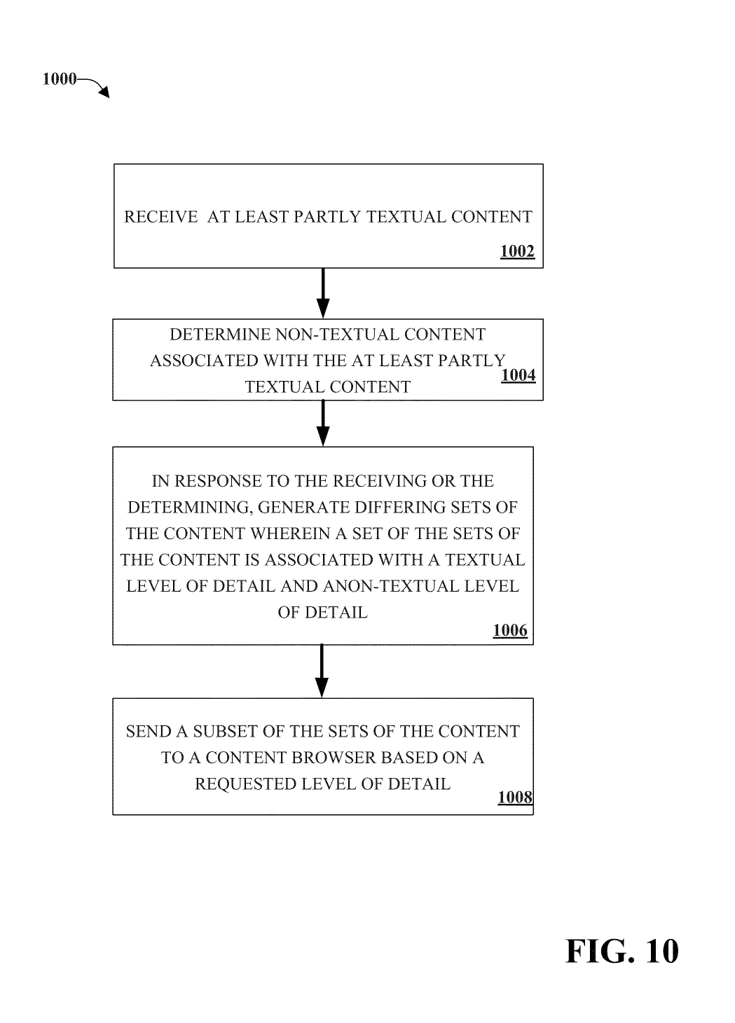

FIGS. 10-12 illustrate methods and/or flow diagrams in accordance with this disclosure. For simplicity of explanation, the methods are depicted and described as a series of acts. However, acts in accordance with this disclosure can occur in various orders and/or concurrently, and with other acts not presented and described herein. Furthermore, not all illustrated acts may be required to implement the methods in accordance with the disclosed subject matter. In addition, those skilled in the art will understand and appreciate that the methods could alternatively be represented as a series of interrelated states via a state diagram or events. Additionally, it should be appreciated that the methods disclosed in this specification are capable of being stored on an article of manufacture to facilitate transporting and transferring such methods to computing devices. The term article of manufacture, as used herein, is intended to encompass a computer program accessible from any computer-readable device or storage media.

Referring now to FIG. 10, there is illustrated an example flow diagram method for auto annotation of content. At 1002, at least partly textual content can be received (e.g., by an input component). At 1004, non-textual content associated with the at least partly textual content can be identified (e.g., by an input component). At 1006, in response to the receiving or the determining, differing sets of content can be generated (e.g., by an auto annotation component) wherein a set of content among the sets of the content is associated with a textual level of detail and a non-textual level of detail. At 1008, at least one set of content among the sets of content can be sent (e.g., by an output component) to a content browser based on a requested level of detail.

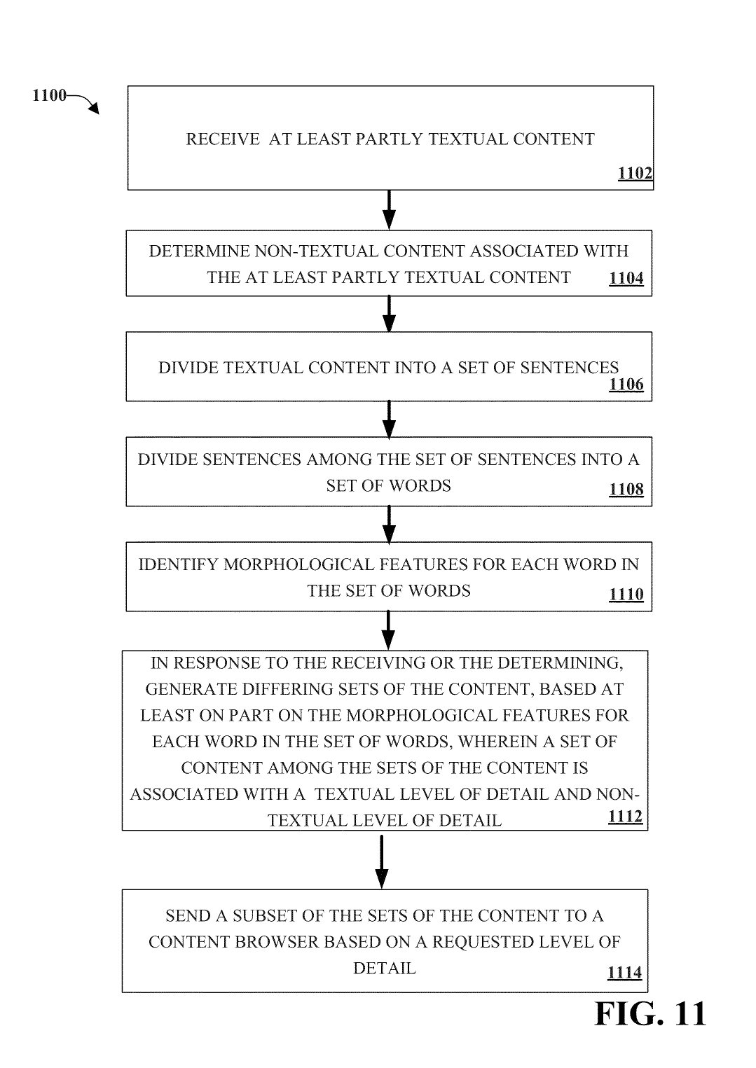

FIG. 11 illustrates an example flow diagram method for auto annotation of content further based on morphological features. At 1102, at least partly textual content can be received (e.g., by an input component). At 1104, non-textual content associated with the at least partly textual content can be identified (e.g., by an input component). At 1106, textual content can be divided (e.g., by a tokenization component) into a set of sentences. At 1108, sentences among the set of sentences can be divided (e.g., by a tokenization component) into a set of words. At 1110, morphological features can be indentified (e.g., by a morphological component) for each word in the set of words. Morphological features can include at least one of a part of speech, a gender, a case, a number, a date, or a proper noun. Morphological features can be identified based at least in part on at least one of a word dictionary, a phrase dictionary, a person data store, a company data store, or a location data store.

At 1112, in response to the receiving or the determining, differing sets of content can be generated (e.g., by an auto annotation component) based at least in part on the morphological features for each in the set of words, wherein a set of content among the sets of the content is associated with a textual level of detail and a non-textual level of detail. At 1114, at least one set of content among the sets of content can be sent (e.g., by an output component) to a content browser based on a desired level of detail.

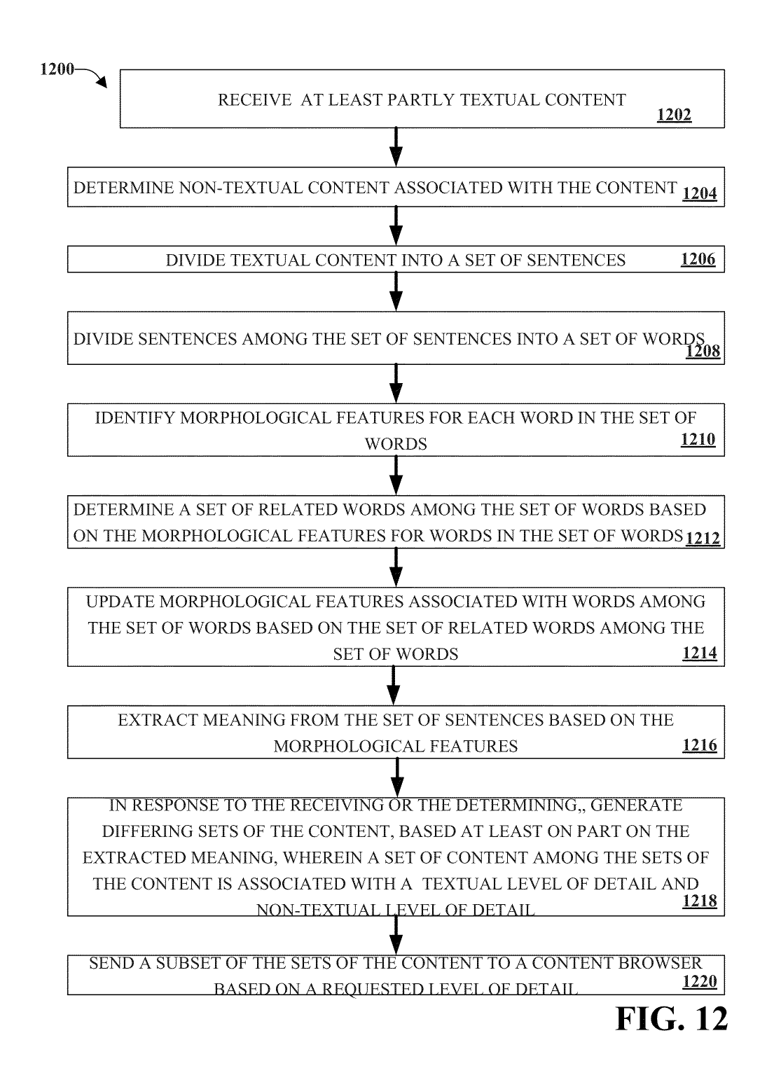

FIG. 12 illustrates an example flow diagram method for auto annotation of content further based on extracted meaning of the content. At 1202, at least partly textual content can be received (e.g., by an input component). At 1204, non-textual content associated with the at least partly textual content can be identified (e.g., by an input component). At 1206, textual content can be divided (e.g., by a tokenization component) into a set of sentences. At 1208, sentences among the set of sentences can be divided (e.g., by a tokenization component) into a set of words. At 1210, morphological features can be indentified (e.g., by a morphological component) for each word in the set of words. At 1212, a set of related words among the set of words can be determined (e.g., by a parsing component) based on the morphological features for words in the set of words. At 1214, morphological features associated with words among the set of words can be updated (e.g., by a morphological component) based on the set of related words among the set of words. At 1216, meaning can be extracted (e.g., by a semantic component) based on the morphological features.

At 1218, in response to the receiving or the determining, differing sets of content can be automatically generated (e.g., by an auto annotation component) based at least in part on the extracted meaning, wherein a set of content among the sets of the content is associated with a textual level of detail and a non-textual level of detail. At 1220, at least one set of content among the sets of content can be sent (e.g., by an output component) to a content browser based on a desired level of detail.

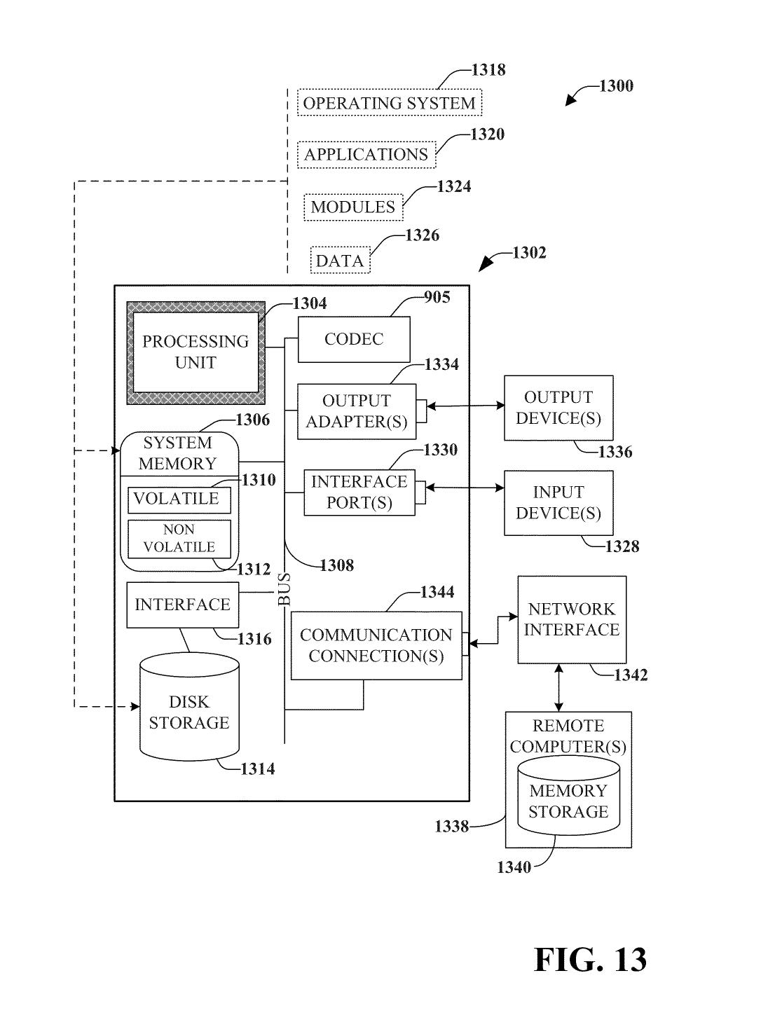

With reference to FIG. 13, a suitable environment 1300 for implementing various aspects of the claimed subject matter includes a computer 1302. The computer 1302 includes a processing unit 1304, a system memory 1306, a codec 1305, and a system bus 1308. The system bus 1308 couples system components including, but not limited to, the system memory 1306 to the processing unit 1304. The processing unit 1304 can be any of various available processors. Dual microprocessors and other multiprocessor architectures also can be employed as the processing unit 1304.

The system bus 1308 can be any of several types of bus structure(s) including the memory bus or memory controller, a peripheral bus or external bus, and/or a local bus using any variety of available bus architectures including, but not limited to, Industrial Standard Architecture (ISA), Micro-Channel Architecture (MSA), Extended ISA (EISA), Intelligent Drive Electronics (IDE), VESA Local Bus (VLB), Peripheral Component Interconnect (PCI), Card Bus, Universal Serial Bus (USB), Advanced Graphics Port (AGP), Personal Computer Memory Card International Association bus (PCMCIA), Firewire (IEEE 1394), and Small Computer Systems Interface (SCSI).

The system memory 1306 includes volatile memory 1310 and non-volatile memory 1312. The basic input/output system (BIOS), containing the basic routines to transfer information between elements within the computer 1302, such as during start-up, is stored in non-volatile memory 1312. By way of illustration, and not limitation, non-volatile memory 1312 can include read only memory (ROM), programmable ROM (PROM), electrically programmable ROM (EPROM), electrically erasable programmable ROM (EEPROM), or flash memory. Volatile memory 1310 includes random access memory (RAM), which acts as external cache memory. According to present aspects, the volatile memory may store the write operation retry logic (not shown in FIG. 13) and the like. By way of illustration and not limitation, RAM is available in many forms such as static RAM (SRAM), dynamic RAM (DRAM), synchronous DRAM (SDRAM), double data rate SDRAM (DDR SDRAM), enhanced SDRAM (ESDRAM).

Computer 1302 may also include removable/non-removable, volatile/non-volatile computer storage media. FIG. 13 illustrates, for example, a disk storage 1314. Disk storage 1314 includes, but is not limited to, devices like a magnetic disk drive, solid state disk (SSD) floppy disk drive, tape drive, Jaz drive, Zip drive, LS-100 drive, flash memory card, or memory stick. In addition, disk storage 1314 can include storage media separately or in combination with other storage media including, but not limited to, an optical disk drive such as a compact disk ROM device (CD-ROM), CD recordable drive (CD-R Drive), CD rewritable drive (CD-RW Drive) or a digital versatile disk ROM drive (DVD-ROM). To facilitate connection of the disk storage devices 1314 to the system bus 1308, a removable or non-removable interface is typically used, such as interface 1316.

It is to be appreciated that FIG. 13 describes software that acts as an intermediary between users and the basic computer resources described in the suitable operating environment 1300. Such software includes an operating system 1318. Operating system 1318, which can be stored on disk storage 1314, acts to control and allocate resources of the computer system 1302. Applications 1320 take advantage of the management of resources by operating system 1318 through program modules 1324, and program data 1326, such as the boot/shutdown transaction table and the like, stored either in system memory 1306 or on disk storage 1314. It is to be appreciated that the claimed subject matter can be implemented with various operating systems or combinations of operating systems.

A user enters commands or information into the computer 1302 through input device(s) 1328. Input devices 1328 include, but are not limited to, a pointing device such as a mouse, trackball, stylus, touch pad, keyboard, microphone, joystick, game pad, satellite dish, scanner, TV tuner card, digital camera, digital video camera, web camera, and the like. These and other input devices connect to the processing unit 1304 through the system bus 1308 via interface port(s) 1330. Interface port(s) 1330 include, for example, a serial port, a parallel port, a game port, and a universal serial bus (USB). Output device(s) 1336 use some of the same type of ports as input device(s) 1328. Thus, for example, a USB port may be used to provide input to computer 1302, and to output information from computer 1302 to an output device 1336. Output adapter 1334 is provided to illustrate that there are some output devices 1336 like monitors, speakers, and printers, among other output devices 1336, which require special adapters. The output adapters 1334 include, by way of illustration and not limitation, video and sound cards that provide a means of connection between the output device 1336 and the system bus 1308. It should be noted that other devices and/or systems of devices provide both input and output capabilities such as remote computer(s) 1338.

Computer 1302 can operate in a networked environment using logical connections to one or more remote computers, such as remote computer(s) 1338. The remote computer(s) 1338 can be a personal computer, a bank server, a bank client, a bank processing center, a certificate authority, a router, a network PC, a workstation, a microprocessor based appliance, a peer device, a smart phone, a tablet, or other network node, and typically includes many of the elements described relative to computer 1302. For purposes of brevity, only a memory storage device 1340 is illustrated with remote computer(s) 1338. Remote computer(s) 1338 is logically connected to computer 1302 through a network interface 1342 and then connected via communication connection(s) 1344. Network interface 1342 encompasses wire and/or wireless communication networks such as local-area networks (LAN) and wide-area networks (WAN) and cellular networks. LAN technologies include Fiber Distributed Data Interface (FDDI), Copper Distributed Data Interface (CDDI), Ethernet, Token Ring and the like. WAN technologies include, but are not limited to, point-to-point links, circuit switching networks like Integrated Services Digital Networks (ISDN) and variations thereon, packet switching networks, and Digital Subscriber Lines (DSL).

Communication connection(s) 1344 refers to the hardware/software employed to connect the network interface 1342 to the bus 1308. While communication connection 1344 is shown for illustrative clarity inside computer 1302, it can also be external to computer 1302. The hardware/software necessary for connection to the network interface 1342 includes, for exemplary purposes only, internal and external technologies such as, modems including regular telephone grade modems, cable modems and DSL modems, ISDN adapters, and wired and wireless Ethernet cards, hubs, and routers.

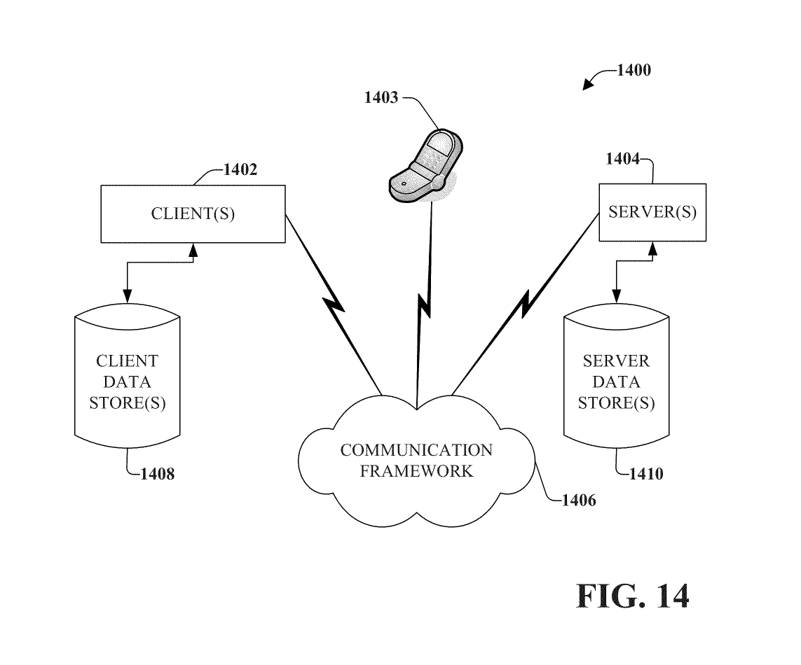

Referring now to FIG. 14, there is illustrated a schematic block diagram of a computing environment 1400 in accordance with the subject specification. The system 1400 includes one or more client(s) 1402, which can include an application or a system that accesses a service on the server 1404. The client(s) 1402 can be hardware and/or software (e.g., threads, processes, computing devices). The client(s) 1402 can house cookie(s) and/or associated contextual information by employing the specification, for example.

The system 1400 also includes one or more server(s) 1404. The server(s) 1404 can also be hardware or hardware in combination with software (e.g., threads, processes, computing devices). The servers 1404 can house threads to perform, for example, identifying morphological features, extracting meaning, auto annotating content, etc. One possible communication between a client 1402 and a server 1404 can be in the form of a data packet adapted to be transmitted between two or more computer processes where the data packet contains, for example, a certificate. The data packet can include a cookie and/or associated contextual information, for example. The system 1400 includes a communication framework 1406 (e.g., a global communication network such as the Internet) that can be employed to facilitate communications between the client(s) 1402 and the server(s) 1404.

Communications can be facilitated via a wired (including optical fiber) and/or wireless technology. The client(s) 1402 are operatively connected to one or more client data store(s) 1408 that can be employed to store information local to the client(s) 1402 (e.g., cookie(s) and/or associated contextual information). Similarly, the server(s) 1404 are operatively connected to one or more server data store(s) 1410 that can be employed to store information local to the servers 1404.

The illustrated aspects of the disclosure may also be practiced in distributed computing environments where certain tasks are performed by remote processing devices that are linked through a communications network. In a distributed computing environment, program modules can be located in both local and remote memory storage devices.

The processes described above can be embodied within hardware, such as a single integrated circuit (IC) chip, multiple ICs, an application specific integrated circuit (ASIC), or the like. Further, the order in which some or all of the process blocks appear in each process should not be deemed limiting. Rather, it should be understood that some of the process blocks can be executed in a variety of orders that are not all of which may be explicitly illustrated herein.

What has been described above includes examples of the implementations of the present invention. It is, of course, not possible to describe every conceivable combination of components or methods for purposes of describing the claimed subject matter, but many further combinations and permutations of the subject embodiments are possible. Accordingly, the claimed subject matter is intended to embrace all such alterations, modifications, and variations that fall within the spirit and scope of the appended claims. Moreover, the above description of illustrated implementations of this disclosure, including what is described in the Abstract, is not intended to be exhaustive or to limit the disclosed implementations to the precise forms disclosed. While specific implementations and examples are described herein for illustrative purposes, various modifications are possible that are considered within the scope of such implementations and examples, as those skilled in the relevant art can recognize

In particular and in regard to the various functions performed by the above described components, devices, circuits, systems and the like, the terms used to describe such components are intended to correspond, unless otherwise indicated, to any component which performs the specified function of the described component (e.g., a functional equivalent), even though not structurally equivalent to the disclosed structure, which performs the function in the herein illustrated exemplary aspects of the claimed subject matter. In this regard, it will also be recognized that the various embodiments includes a system as well as a computer-readable storage medium having computer-executable instructions for performing the acts and/or events of the various methods of the claimed subject matter.

What is claimed is:

1. A network service, comprising:
a memory that stores computer executable components; and
a processor that facilitates execution of computer executable components stored in the memory, the computer executable components comprising:
an input component that receives content, wherein the content is at least partly textual content;
an auto annotation component that generates differing sets of the content in response to reception of the content wherein a set of the sets of the content is associated with a level of detail of a set of different levels of detail; and
an output component that sends at least one set of the sets of the content to a content browser based on a specified level of detail.

2. The network service of claim 1, the computer executable components further comprising:
a tokenization component that divides the textual content into a set of sentences.

3. The network service of claim 2, wherein at least a subset of the set of sentences are divided into respective sets of words.

4. The network service of claim 3, the computer executable components further comprising:
a morphological component that identifies morphological features for words in the set of words wherein the auto annotation component generates the differing sets of the content based on the morphological features.

5. The network service of claim 4, wherein the morphological features include at least one of a part of speech, a gender, a case, a number, a date, or a proper noun.

6. The network service of claim 4, wherein the morphological component identifies the morphological features based at least in part on at least one of a word dictionary, a phrase dictionary, a person data store, a company data store, or a location data store.

7. The network service of claim 4, the computer executable components further comprising:
a parsing component that determines, for the words in the set of words, a set of related words among the set of words based on the morphological features.

8. The network service of claim 7, wherein the morphological component updates the morphological features associated with the words of the set of words based on the set of related words.

9. The network service of claim 8, the computer executable components further comprising:
a semantic component that extracts meaning of sentences of the set based on the morphological features.

10. The network service of claim 9, wherein the auto annotation component generates the differing sets of the content based on the meaning extracted by the semantic component.

11. The network service of claim 1, the computer executable components further comprising:
a context component that determines at least one associated content wherein the at least one associated content is at least one of an image, a sound, or a video.

12. The network service of claim 11, wherein the auto annotation component includes the at least one associated content within the sets of content based on the level of detail associated with the set of the sets of the content.

13. The network service of claim 1, wherein the output component sends the at least one set of the sets of the content to the content browser based on at least one of a user level of detail selection, a hardware profile, or a content browser setting.

14. A method, comprising:
receiving, by at least one computing device including at least one processor, at least partly textual content;
determining non-textual content associated with the at least partly textual content;
in response to the receiving or the determining, generating differing sets of the content wherein a set of the sets of the content is associated with a textual level of detail and a non-textual level of detail; and
sending a subset of the sets of the content to a content browser based on a requested level of detail.

15. The method of claim 14, further comprising:
dividing the textual content into a set of sentences;
dividing sentences among the set of sentences into a set of words; and
identifying morphological features for each word in the set of words.

16. The method of claim 15, wherein the generating the differing sets of content is further based on the identified morphological features for each word in the set of words.

17. The method of claim 15, wherein morphological features include at least one of a part of speech, a gender, a case, a number, a date, or a proper noun.

18. The method of claim 15, wherein the identifying the morphological features for each word in the set of words is based at least in part on at least one of a word dictionary, a phrase dictionary, a person data store, a company data store, or a location data store.

19. The method of claim 15, further comprising:
determining a set of related words among the set of words based on the morphological features for words in the set of words;
updating the morphological features associated with the words among the set of words based on the set of related words among the set of words; and
extracting meaning from the set of sentences based on the morphological features wherein the generating the differing sets of the content is further based on the extracted meaning

20. The method of claim 19, wherein the non-textual content is video content.

21. The method of claim 20 wherein the non-textual level of detail associated with the video content is based on at least one of video compression, video size, or video length.

22. The method of claim 19, wherein the non-textual content is image content.

23. The method of claim 22, wherein the non-textual level of detail associated with the image content is based on at least one of image compression, image size, or number of images.

24. The method of claim 19, wherein the non-textual content is audio content.

25. The method of claim 24, wherein the non-textual level of detail associated with the image content is based on at least one of audio compression, audio size, or audio length.

26. A computer-readable storage medium comprising computer-executable instructions that, in response to execution, cause a computing system to perform operations, comprising:
receiving content including receiving textual content of the content and non-textual content of the content;
in response to the receiving, generating differing sets of the content having respective textual levels of detail and respective non-textual levels of detail; and
sending at least one set of the sets of the content to a content browser based on a designated level of detail.
